(19) United States
(12) Patent Application Publication
(10) Pub. No.: US 2015/0321456 A1
(43) Pub. Date: Nov. 12, 2015

(54) POLYMERS, ARTICLES COMPRISING POLYMERS, AND METHODS OF MAKING AND USING THE SAME

(71) Applicant: SABIC Global Technologies B.V., Bergen op Zoom (NL)

(72) Inventor: Steven Marc Gasworth, Novi, MI (US)

(21) Appl. No.: 14/801,956

(22) Filed: Jul. 17, 2015

Related U.S. Application Data
(63) Continuation of application No. 14/758,366, filed on Jun. 29, 2015.
(60) Provisional application No. 61/748,186, filed on Jan. 2, 2013.

(51) Int. Cl. B32B 27/36; C08K 5/00; C08K 3/00; B32B 27/08; C08L 69/00

(52) U.S. Cl. CPC B32B 27/365; B32B 27/08; C08L 69/00; C08K 3/0008; C08K 5/0008; B32B 2605/006; B32B 2307/712; B32B 2307/306; C08L 2207/04

(57) ABSTRACT

A polymer part can comprise: a first layer comprising a first polymer, wherein the first layer allows greater than or equal to 5% of visible light to transfer through it; and optionally a second layer comprising a second polymer; wherein the second layer is opaque; wherein the polymer part comprises a phase change material, wherein when exposed to cyclic temperature and solar radiation conditions for a period of time, the polymer part has a lower effective temperature as compared to a polymer part without a phase change material when exposed to the same cyclic temperature and solar radiation conditions for the same period of time.

### CROSS-REFERENCE TO RELATED APPLICATIONS

This application is a continuation application of U.S. patent application Ser. No. 14/758,366 filed Jun. 29, 2015 which claims priority to International Application No. PCT/US2014/010047 filed Jan. 2, 2014 and U.S. Patent Application Ser. No. 61/748,186 filed Jan. 2, 2013. The related applications are incorporated herein by reference.

### TECHNICAL FIELD

The present disclosure relates to polymers with improved properties, such as weatherability, under cyclic temperature conditions, articles comprising these polymers, and methods of making and using the same.

### BACKGROUND

Polymers have physical and chemical properties that are useful in a wide variety of applications. For example, polycarbonates are a class of polymers which, because of their excellent breakage resistance, have replaced or are replacing glass in many products, such as automobiles, head lamps, safety shields, eyewear, and windows (e.g., glazing). However, many polycarbonates possess properties that can be disadvantageous in some applications, such as low abrasion resistance and susceptibility to degradation from exposure to ultraviolet (UV) radiation. Thus, it can be challenging to use polycarbonate in applications, such as automotive applications (e.g., rooflites, windshields, headlamps, etc.), which are exposed to ultraviolet light and/or an abrasive environment.

To lessen the problems associated with the use of polycarbonate glazing in automobile applications, a coating can be applied to the glazing where the coating contains a UV absorber and/or an abrasion resistant material. However, weathering of coated polycarbonate glazing is accelerated by higher temperatures, which decreases the effective service life of the polycarbonate glazing. For example, higher temperatures can be observed in rooflites where the rooflite is oriented generally horizontal, which enhances exposure to solar radiation. Additionally, higher temperatures can be observed in rooflites where the rooflite has a dark border or blackout portion, generally provided by ink applied to the rooflite or provided by the second shot in a two-shot injection molding process. The dark border or blackout portion generally attains a higher average temperature than the transparent zone, which can decrease the effective service life of the polycarbonate glazing. Furthermore, if the rooflite incorporates additives that absorb solar infrared radiation, the average temperature can also be increased, thereby accelerating weathering, and decreasing the effective service life. Further still, adhesion of the coating to the polycarbonate glazing can be compromised by cyclic temperature changes, which often occur in outdoor applications.

Thus, there is a need for compositions having improved weatherability, durability, and adhesion to other components when exposed to cyclic temperature and/or radiation conditions.

### SUMMARY

In an embodiment, a polymer part comprises: a first layer comprising a first polymer and a phase change material, wherein the first layer allows greater than or equal to 5% of visible light to transfer through it; and wherein when exposed to cyclic temperature and solar radiation conditions for a period of time, the polymer part has a lower effective temperature as compared to a polymer part without a phase change material when exposed to the same cyclic temperature and solar radiation conditions for the same period of time.

In an embodiment, a polymer part comprises: a first layer comprising a first polymer, wherein the first layer allows greater than or equal to 5% of visible light to transfer through it; and a second layer comprising a second polymer and a phase change material, wherein the second layer is opaque; wherein when exposed to cyclic temperature and solar radiation conditions for a period of time, the polymer part has a lower effective temperature as compared to a polymer part without a phase change material when exposed to the same cyclic temperature and solar radiation conditions for the same period of time.

In an embodiment, a polymer part comprises: an opaque first layer comprising a first polymer and a phase change material; wherein when exposed to cyclic temperature and solar radiation conditions for a period of time, the polymer part has a lower effective temperature as compared to a polymer part without a phase change material exposed to the same cyclic temperature and solar radiation conditions for the same period of time.

In an embodiment, an article comprises: a polymer part comprising a first layer comprising a first material and a phase change material; and a second layer comprising a second material, wherein the second layer is bonded to the first layer or wherein the second layer is coated on the first layer; wherein when the article is exposed to cyclic temperature and/or solar radiation conditions for a period of time, differential thermal expansion of the first layer and second layer is reduced compared to an article without a phase change material exposed to the same cyclic temperature and/or solar radiation conditions for the same period of time.

In an embodiment, a glazing part comprises: a first layer comprising a first polymer and a phase change material; wherein when the glazing part is exposed to cyclic temperature and solar radiation conditions for a period of time, a time-average total solar transmittance of the glazing part is reduced compared to a glazing part without a phase change material exposed to the same cyclic temperature and solar radiation conditions for the same period of time.

In an embodiment, a method of making a polymer part comprises: molding a first layer comprising a first polymer, wherein the first layer allows greater than or equal to 5% of visible light to transfer through it; molding a second layer comprising a second polymer, wherein the second layer is opaque; incorporating a phase change material in at least one of the first polymer or the second polymer; and exposing the polymer part to cyclic temperature and solar radiation conditions for a period of time; wherein the polymer part has a lower effective temperature as compared to a polymer part without a phase change material when exposed to the same cyclic temperature and solar radiation conditions for the same period of time.

In an embodiment, a method of making a polymer part comprises: forming a first layer comprising a first polymer and a phase change material, wherein the first layer allows greater than or equal to 5% of visible light to transfer through it; and exposing the polymer part to cyclic temperature and solar radiation conditions for a period of time; wherein the polymer part has a lower effective temperature as compared to a polymer part without a phase change material when exposed to the same cyclic temperature and solar radiation conditions for the same period of time.

In an embodiment, a method of making a polymer part comprises: forming an opaque first layer, wherein the first layer comprises a first polymer; incorporating a phase change material in the first polymer; and exposing the polymer part to cyclic temperature and solar radiation conditions for a period of time; wherein the polymer part has a lower effective temperature as compared to a polymer part without a phase change material when exposed to the same cyclic temperature and solar radiation conditions for the same period of time.

In an embodiment, a method of making an article comprises: forming a polymer part comprising a first layer comprising a first material and a phase change material to form the article; bonding or coating a second layer comprising a second material to the first layer; and exposing the article to cyclic temperature and/or solar radiation conditions; wherein when the article is exposed to cyclic temperature and/or solar radiation conditions for a period of time, differential thermal expansion of the first layer and second layer is reduced compared to an article without a phase change material exposed to the same cyclic temperature and/or solar radiation conditions for the same period of time.

In an embodiment, a method of making a glazing part comprises: forming a first layer comprising a first polymer and a phase change material; and exposing the glazing part to cyclic temperature and solar radiation conditions for a period of time; wherein a time-average total solar transmittance of the glazing part is reduced compared to a glazing part without a phase change material when exposed to the same cyclic temperature and solar radiation conditions for the same period of time.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1 is a graphical illustration of the increase in polymer temperature as stored heat increases for a polymer comprising a phase change material and a polymer without the phase change material.

FIG. 2 is a view of a glazing element.

FIG. 3 is another view of a glazing element.

FIG. 4 is a view of a glazing element with an opaque border disposed around a perimeter of a transparent zone of the glazing element.

### DETAILED DESCRIPTION

Articles and polymer parts as disclosed herein made from polymer compositions comprising a phase change material can experience a reduced level or rate of destructive cumulative effects of cyclic temperatures on the polymer parts (e.g., plastic parts) resulting from solar exposure and/or differential thermal expansion relative to a coating on the polymer part or relative to another part to which the polymer part is bonded. For example, in the case of cyclic temperature with solar exposure (i.e., a diurnal cycle), the polymer parts disclosed herein and articles made therefrom can experience a reduction in the effective temperature (i.e., an irradiance-weighted average temperature over a year at a location, specific to the temperature sensitivity of the material, i.e. the activation energy for weathering) that reflects the cumulative effect of combined radiation and heat where a lower effective temperature correlates with a longer service lifetime. In the case of cyclic ambient or service temperatures with differential thermal expansion of the polymer part relative to a coating or to another part to which the polymer part is bonded, the polymer compositions and polymer parts derived therefrom as disclosed herein, can reduce the magnitude of the temperature excursions (relative to a baseline temperature) experienced by the part, averaged over a temperature cycle or a representative series of cycles. Reduced average magnitude of temperature excursions can provide a reduced magnitude of differential expansion (averaged over a cycle or a series of cycles) and in turn can provide reduced or slower cumulative wear or fatigue of coated or bonded systems. In multilayer articles it can desirable to incorporate the PCM in whichever layer comprises a material having a higher coefficient of thermal expansion (CTE), since the material with the higher CTE will have a higher propensity to expand.

Disclosed herein, in various embodiments, are polymers comprising a phase change material (PCM), that when in the form of an article (e.g., polymer part such as a glazing, applique (e.g., automotive applique), etc.), can provide increased service lifetimes, and/or improved robustness of bonding and/or coatings of polymer parts when exposed to cyclic temperature conditions over a period of time. For example, a polymer part can comprise a first layer comprising a first polymer and a phase change material, where the first layer allows greater than or equal to 5% of visible light to transfer through it or the first layer can be opaque (e.g., allowing less than or equal to 1% of visible light to transfer through it). A polymer part can also comprise a first layer comprising a first polymer, where the first layer allows greater than or equal to 5% of visible light to pass through it and a second layer comprising a second polymer and a phase change material, where the second layer is opaque. The polymer part can have a lower effective temperature compared to a polymer part without a phase change material when exposed to the same cyclic temperature and solar radiation conditions for the same period of time. In a two-layer polymer part, the first layer can have a perimeter and the second layer can be disposed around the perimeter of the first layer or the second layer can have a perimeter and the first layer can be disposed around the perimeter of the second layer. A polymer part can also comprise a first layer comprising a first material and a phase change material and a second layer comprising a second material, where the second layer is bonded to or coated on the first layer. The first material can comprise a polymer and the second material can comprise a polymer, a metal, glass, ceramic, etc., as well as combinations comprising at least one of the foregoing. When the polymer part is exposed to cyclic temperature and/or solar radiation conditions for a period of time, cumulative differential thermal expansion of the polymer part can be reduced compared to a polymer part without a phase change material exposed to the same cyclic temperature and/or solar radiation conditions for the same period of time.

Polymers for use in outdoor applications are generally either inherently weatherable or are protected by coatings that at least partially block solar UV radiation. Some inherently UV weatherable polymers include polymethyl methacrylate, polyvinylidene fluoride, and polyvinyl fluoride. Polycarbonate polymers generally have a UV radiation blocking protective coating, e.g., for automotive glazing and/or other automotive exterior application such as headlamp lenses and appliques. Under exposure to diurnal cyclic conditions (i.e., a 24 hour cycle of varying temperature and radiation conditions at a specific location) for a period of time, the weathering of the polycarbonate can be accelerated, e.g., by such factors as generally horizontal orientation (e.g. in the case of a rooflite) which tends to enhance exposure to solar radiation, dark tint or color which can increase average temperature of the polycarbonate, and the presence of IR absorbers in the polycarbonate or its coatings which can also increase the average temperature of the polycarbonate; thus, the service lifetime of the article can be reduced.

Accordingly, the desire to improve weathering of coated polycarbonate, e.g., for automotive rooflites, arises in response to several important concerns such as: rooflites in automobiles are generally oriented horizontally, which enhances exposure to solar radiation; UV radiation blocking coatings, e.g., on rooflites, are generally not over-coated with a plasma coating which would generally tend to inhibit micro-cracking and/or delamination; rooflites can have a dark border or blackout portion, e.g., provided by ink applied to the initially transparent glazing or by second shot injection molding, where the second shot portion of the glazing generally attains a higher average temperature than other portions of the rooflite, tending to accelerate the weathering process; and rooflites may incorporate additives that absorb solar infrared (IR) radiation that generally increase the average glazing temperature, which can, in turn, accelerate the weathering process. For example, any dark colored (e.g., black) component of a vehicle (e.g., appliques) exposed to solar radiation can be prone to faster weathering-related damage than lightly colored and/or lightly tinted components. This includes a second shot border injected behind the transparent first shot in glazing applications.

As disclosed herein, a PCM can be incorporated into a polymer used in an application that is subject to cyclic temperature conditions (e.g., diurnal cycle) to, for example, limit or delay temperature rise of a polymer matrix in which the PCM resides. For example, in glazing applications, the PCM can be incorporated into a substrate layer. The substrate layer can offer adequate space for incorporation of the PCM and can generally be the main location for solar energy absorption because either the substrate has a dark color or the substrate contains infrared (IR) absorbers. Alternatively or in addition, the PCM can be incorporated into a coating layer, e.g., a weathering layer and/or an abrasion resistant layer. Generally, a PCM undergoes a phase change at a characteristic phase change temperature to absorb energy as latent heat without a substantial increase in temperature (i.e., much less than for a fixed phase of the same material absorbing the same energy). Generally, a PCM also undergoes a phase change at a characteristic phase change temperature to release latent heat without a substantial decrease in temperature (i.e., much less than for a fixed phase of the same material releasing the same energy). As compared to a polymer without a PCM, for which heat is stored exclusively in a sensible form (i.e., with an increase in temperature) causing a continuous temperature rise with heat input, a polymer comprising a PCM can sustain a smaller temperature rise for a given heat input.

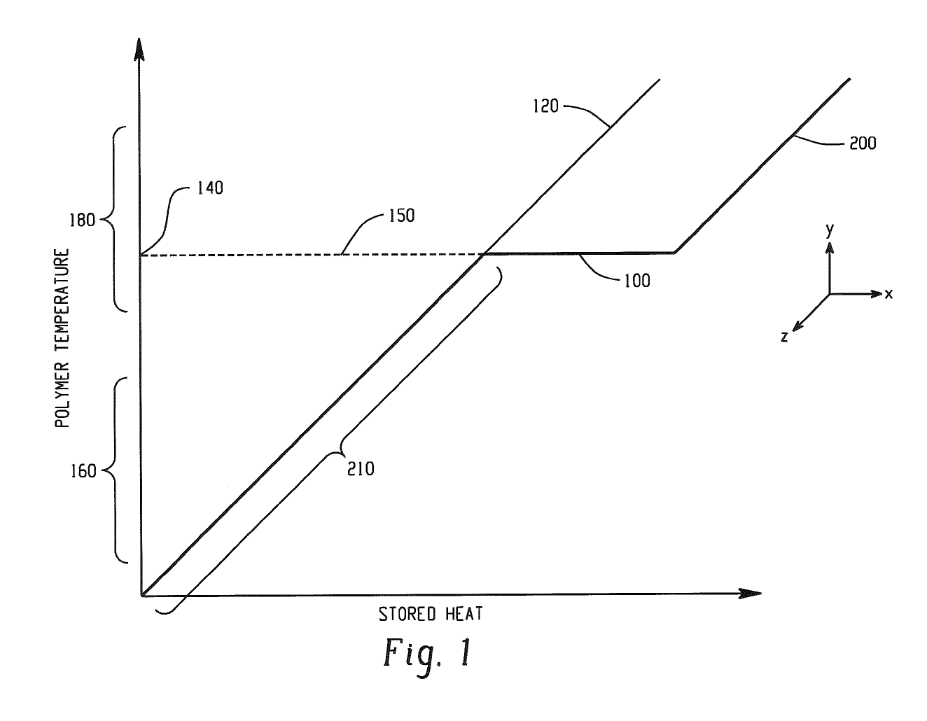

For example, FIG. 1 illustrates temperature trajectories of a polymer comprising a PCM and a polymer without a PCM. Stored heat is illustrated along the x-axis, with increasing polymer temperature illustrated on the y-axis from a cold climate range 160 to a hot climate range 180. Various temperature trajectories are illustrated in which 210 refers to a segment of a temperature trajectory of a polymer comprising a PCM and a polymer not comprising a PCM until the phase change temperature 140 of the PCM is reached, which is illustrated where the dashed line 150 intersects with the y-axis. Once the phase change temperature 140 of the PCM is reached from lower temperatures, and as heat storage increases further, the temperature initially follows a plateau 100 at the phase change temperature 140 for the polymer containing the PCM, but increases continuously on another trajectory segment 120 for the polymer without the PCM. Eventually, the polymer with the PCM resumes sensible heat storage, indicated by trajectory segment 200 in FIG. 1, which reflects the finite latent heat storage capacity of a finite volume of the PCM.

As can be seen in FIG. 1, a polymer comprising PCM can also release energy at the phase change temperature without a substantial decrease in temperature as compared to a polymer without a PCM. The PCM can be selected so that its phase change temperature falls within the temperature range of interest experienced by the polymer in the absence of a PCM. Based on FIG. 1, the average temperature of a part over a cycle can be less with the inclusion of a phase change material as compared to the average temperature of a part over the same cycle without the inclusion of a phase change material, since the plateau in FIG. 1 for the polymer comprising PCM will contribute to a lower average temperature rise as compared to a polymer without the PCM incorporated.

A PCM can be incorporated into a polymer or polymer article to assist in lowering the effective temperature of a polymer that is subject to a diurnal cycle (varying temperature and radiance over the course of a 24 hour day). For example, real world exposure of polymers with respect to weatherability can be represented by a constant effective temperature, which is an irradiance-weighted average temperature over the span of a year at a given location, specific to the temperature sensitivity of the material, i.e. the activation energy for weathering. Under a diurnal cycle of temperature and radiation conditions, a PCM with a characteristic phase change temperature in the range indicated in FIG. 1, can reduce the peak surface temperature of the polymer and thereby tend to reduce the effective temperature, especially since temperature peaks can be roughly correlated with irradiance peaks. Temperature and light constantly change outdoors and materials exposed to outdoor conditions receive sunlight at varying temperatures, so an irradiance weighted average temperature can offer a useful way to characterize exposure conditions (i.e., temperature and irradiance) that affect weatherability of a given material characterized by an activation energy for weathering. Hot climate temperature range 180 and cold climate temperature range 160 as illustrated in FIG. 1 can, for example, refer respectively to summer and winter at a common location (e.g., New England) or to characteristic climates at different locations (e.g., Phoenix, Ariz. (hot) and Anchorage, Ak. (cold)).

Using a PCM that decreases the effective temperature can provide an improvement in the service lifetime of polymers and polymer articles exposed to the outdoors as compared to polymers and polymer articles that do not contain a PCM. For example, the service lifetime of coated polycarbonate glazing as compared to a coated polycarbonate glazing without a PCM can be increased, since the weathering of coated polycarbonate is generally accelerated by higher temperatures. The PCM can be added concurrently with an IR absorbing additive, e.g., to the polymer used to make a glazing, to counter or, in some cases, even offset, the tendency of the IR absorbing additive to raise the effective temperature by several degrees which can reduce the service lifetime of the glazing. Alternatively, or in addition to the PCM being added concurrently with the IR absorbing additive, the PCM can be added in the blackout portion (i.e., border) of a polymer part (e.g., glazing) to counter, or even reverse, the tendency of the blackout zone to raise the effective temperature by several degrees, which, as described, can limit the service lifetime of the glazing. It is to be understood that the blackout portion can be formed by any desired method, including, but not limited to, printing, injection molding, etc., wherein, when injection molded, the blackout portion can be the second shot in a two-shot injection molding process. Furthermore, when the PCM is incorporated in the blackout portion of a polymer part as described herein, the blackout portion can have a lower effective temperature compared to a blackout portion without a PCM, which can provide a lower effective temperature overall for the polymer part.

Another benefit of reducing the effective temperature of the polymer is to relieve the tradeoff between weathering and abrasion performance of the protective coating. The loading of UV radiation absorbers in a protective coating for glazing can be increased to improve weatherability, but this can decrease the abrasion resistance of the coating because the UV-active components are generally organic. This results in a tradeoff between weatherability and abrasion resistance, which arises in applications such as rooflites where the UV radiation blocking coating is generally not over-coated with a more abrasion resistant coating, e.g., a plasma coating. However, since incorporation of a PCM into the polymer improves the weathering performance independently of the UV absorber loading in the protective coating the abrasion resistance of the UV absorber-bearing protective coating does not have to be compromised to the same degree with the use of a PCM in a polymer to provide sufficient weathering protection for an anticipated service lifetime (e.g., for automotive components, generally about 10 years).

Furthermore, reducing the effective temperature of the polymer in hot climates can improve the overall consistency of the weathering performance across geographical regions which yield different effective temperatures. For example, the polymer temperature can generally be greater in a hot climate as compared to a cold climate. This generally means that the effective temperature of the polymer is higher, and therefore the overall weathering performance is worse and the service life is shorter, in hot climates than in cold climates. An improvement in hot-climate performance can assist in bringing the hot-climate weathering performance and cold-climate weathering performance closer together. Addition of a phase change material to a polymer can improve the weathering performance in hot-climates by decreasing the effective temperature of the polymer, which tends to extend polymer service lifetime.

Alternatively or in addition to lowering the effective temperature of a polymer with the inclusion of a PCM, the robustness of bonding and/or of coatings attached to a polymer part can be improved under cyclic temperature conditions. Such variations in temperature can cause polymers to expand and contract cyclically (i.e., expand in hot conditions and contract in cold conditions). Such expansion and contraction can accelerate failure of bonding and/or coatings by fatigue, or force a compromise of other system attributes (e.g., coating hardness in favor of coating compliance) to avoid premature failure due to thermally-induced cyclic stress. Fatigue generally refers to cumulative wear of the bonding (and/or coatings) due to cyclic differential thermal expansion of two elements bonded together (and/or coatings and their corresponding substrate). A PCM can help reduce cumulative expansion and contraction of the polymer part and/or cumulative differential expansion of the polymer part relative to its coatings or to another part to which the PCM-bearing polymer part is bonded.

A PCM can be selected with a characteristic phase change temperature within the range of temperatures normally experienced by a polymer part, with an optional coating and/or optional other layers bonded thereto, under cyclic temperature conditions. Use of a PCM, under cyclic temperature conditions, can provide reduced temperature excursions that can reduce the extremes of cyclic mechanical stress and/or the cumulative wear on the bonding and/or coating due to cyclic thermal expansion. Any cyclic temperature source, including but not limited to, solar radiation and/or other climate related conditions, can cause cyclic thermal expansion and cyclic mechanical stress on bonding and/or coating, so polymers incorporating a PCM, or articles made therefrom, can be used for indoor and outdoor applications. By reducing fatigue induced by cyclic temperature conditions, and thereby improving the tolerance of the system for such conditions, incorporation of a PCM into a polymer can provide greater flexibility to address other system attributes, including cost, with the desirable prospect of overall system improvement.

Alternatively, or in addition to lowering the effective temperature (i.e., improving the weathering performance of polymers with the incorporation of a PCM) and/or improving the robustness of a bonding and/or a coating of a polymer part, it can be desirable to provide glazing with a lower time-average total solar transmittance (Tts) in hot climates compared to cold climates. An advantage of transparent polymers formed into articles comprising a PCM compared to transparent polymers formed into articles not comprising a PCM can be found in a lower time-average Tts in a hot climate compared to a cold climate. When referring to Tts, it is generally understood that the articles, and/or parts, and/or polymers comprise transparent materials. In hot climates, a relatively low Tts can help reduce the load on air conditioners, e.g., in vehicles, buildings, and stadiums, while in cold climates, a relatively high total solar transmittance can help reduce the load on heating systems, e.g., in vehicles, buildings, and stadiums. Glazing, e.g., polycarbonate glazing, with a lower Tts in hot climates versus cold climates can generally be useful and can potentially increase the value of polycarbonate glazing for vehicles, e.g., electric-drive vehicles discussed in further detail below. The Tts can be reduced by incorporating IR absorbing or IR reflecting elements into the glazing. However, neither of these options addresses the need for climate-dependent Tts.

Generally, Tts refers to the sum of the direct solar transmittance and the secondary heat transfer to the inside of a structure (e.g., a vehicle or a building). The secondary heat transfer is the contribution to the total heat transfer to the inside of the structure associated with elevation of the glazing temperature due to absorption of solar energy by the glazing. Under cyclic temperature and solar radiation conditions, a PCM with a characteristic phase change temperature, e.g., in the range indicated in FIG. 1, incorporated in a glazing, can reduce the glazing temperature resulting from a given energy absorption, which in turn can lead to a reduction in the secondary heat transfer as compared to a glazing without a PCM. Under cyclic temperature conditions (e.g. a diurnal cycle), and averaged over one or more temperature cycles, the secondary heat transfer and thereby the Tts (e.g., time-average Tts) can be reduced as compared to a glazing without a PCM.

With relevant temperatures qualitatively as in FIG. 1, the tendency of the PCM to reduce time-average Tts generally occurs only in hot climates, while the PCM has no effect in cold climates. Such a result is desired since reduction of time-average Tts is advantageous in hot climates, but counter-productive in cold climates. In certain applications, e.g., electric-drive vehicles, such climate-dependent Tts reduction can be especially useful, since otherwise a climate-independent Tts reduction would tend to increase the range (i.e. the travel distance provided by a fully-charged battery) of electric-drive vehicles in hot climate at the expense of the range of electric-drive vehicles in cold climate, due to the opposite effect of reduced Tts on the air conditioner load (reduced) and heater load (increased) in the respective climates. This is because the air conditioner and heater in an electric-drive vehicle draw energy from the same batteries used for propulsion of the vehicle. In other words, reducing the load on the air conditioner of an electric-drive vehicle by reducing time-average Tts in a hot climate during daylight hours can effectively increase the range of the vehicle since the air conditioner will be drawing less energy from the batteries. It is to be understood that the reduction in Tts is an incremental effect, meaning that the baseline Tts is largely determined by the polymer material and any dispersed colorants and/or IR absorbing agents, and that the change in Tts due to the incorporation of PCM would generally be small in comparison to the baseline value. The change in Tts due to the PCM is generally not an instantaneous change, but rather a change in an average or effective Tts value over a number of temperature cycles. It can be possible for an incremental (hot-climate) reduction in time-average Tts to yield a significant annual or seasonal savings in utility costs, e.g., for building or stadium air conditioning, fuel costs for a fleet of buses, etc.

The polymers disclosed herein can be used in various applications including, but not limited to, glazing (e.g., rooflite, rear window, side window, windshield in automotive applications), appliques (e.g., automotive appliques), headlamps (e.g., headlamp lenses), outdoor applications including, but not limited to, building and construction (e.g., buildings, stadiums, greenhouses, etc.). Use of a PCM in glazing, e.g., polycarbonate glazing and/or polycarbonate glazing having a polycarbonate/acrylonitrile butadiene styrene (PC/ABS) second shot in a two-shot injection molding process, can have commercial significance in providing enhanced value as compared to glazing not containing a PCM. For example, in glazing formed in a two-shot injection molding process and comprising a polycarbonate first shot and a PC/ABS second shot, the PC/ABS can include a PCM incorporated therein and/or the PCM can be introduced simultaneously with the second shot. The second shot can be clear, opaque, and/or dark (e.g., black). When the second shot comprises an opaque or dark material, fewer limitations are placed on the PCM in terms of size, loading, and/or material as can be the case when the second shot comprises a clear material. As referred to herein, opaque generally refers to less than or equal to 1% of visible light being able to transfer through an object.

Possible polymers which can incorporate a PCM include, but are not limited to, oligomers, polymers, ionomers, dendrimers, copolymers such as graft copolymers, block copolymers (e.g., star block copolymers, random copolymers, etc.) and combinations comprising at least one of the foregoing. Examples of such polymers include, but are not limited to, polycarbonates (e.g., blends of polycarbonate (such as, polycarbonate-polybutadiene blends, copolyester polycarbonates)), polystyrenes (e.g., homopolymers of polystyrene, copolymers of polycarbonate and styrene, polyphenylene ether-polystyrene blends), polyimides (e.g., polyetherimides), acrylonitrile-butadiene-styrene (ABS), polyalkylmethacrylates (e.g., polymethylmethacrylates (PMMA)), polyesters (e.g., copolyesters, polythioesters), polyolefins (e.g., polypropylenes (PP) and polyethylenes, high density polyethylenes (HDPE), low density polyethylenes (LDPE), linear low density polyethylenes (LLDPE)), polyamides (e.g., polyamideimides), polyarylates, polysulfones (e.g., polyarylsulfones, poly sulfonamides), polyphenylene sulfides, polytetrafluoroethylenes, polyethers (e.g., polyether ketones (PEK), polyether ether ketones (PEEK), polyethersulfones (PES)), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides (such as polyvinylchlorides), polyvinyl nitriles, polyvinyl esters,), polysulfonates, polysulfides, polyureas, polyphosphazenes, polysilazanes, polysiloxanes, fluoropolymers (e.g., polyvinyl fluoride (PVF), polyvinylidene fluoride (PVDF), fluorinated ethylene-propylene (FEP), polyethylenetetrafluoroethylene (PETFE), polytetrafluoroethylene (PTFE)) and combinations comprising at least one of the foregoing.

More particularly, the polymers can include, but are not limited to, polycarbonate resins (e.g., LEXAN* resins, commercially available from SABIC'S Innovative Plastics Business), polyphenylene ether-polystyrene resins (e.g., NORYL* resins, commercially available from SABIC'S Innovative Plastics Business), polyetherimide resins (e.g., ULTEM* resins, commercially available from SABIC'S Innovative Plastics Business), polybutylene terephthalate-polycarbonate resins (e.g., XENOY* resins, commercially available from SABIC'S Innovative Plastics Business), copolyestercarbonate resins (e.g. LEXAN* SLX resins, commercially available from SABIC'S Innovative Plastics Business) polycarbonate/acrylonitrile butadiene styrene resin (e.g., CYCOLOY*, commercially available from SABIC'S Innovative Plastics Business), and combinations comprising at least one of the foregoing resins. Even more particularly, the polymers can include, but are not limited to, homopolymers and copolymers of a polycarbonate, a polyester, a polyacrylate, a polyamide, a polyetherimide, a polyphenylene ether, or a combination comprising at least one of the foregoing resins. The polycarbonate can comprise copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate), and combinations comprising at least one of the foregoing, for example, a combination of branched and linear polycarbonate.

The polymers can include various additives ordinarily incorporated into polymer compositions of this type, with the proviso that the additive(s) are selected so as to not significantly adversely affect the desired properties of the polymer, for example, transparency. Such additives can be mixed at a suitable time during the mixing of the components for forming articles made from the polymers. Exemplary additives include impact modifiers, fillers, reinforcing agents, antioxidants, heat stabilizers, light stabilizers, ultraviolet (UV) light stabilizers (e.g., UV absorbing), plasticizers, lubricants, mold release agents, antistatic agents, colorants (such as carbon black and organic dyes), surface effect additives, infrared radiation stabilizers (e.g., infrared absorbing), flame retardants, thermal conductivity enhancers, and anti-drip agents. A combination of additives can be used, for example a combination of a heat stabilizer, mold release agent, and ultraviolet light stabilizer. In general, the additives are used in the amounts generally known to be effective. The total amount of additives (other than any impact modifier, filler, or reinforcing agents) is generally 0.001 wt. % to 30 wt. %, based on the total weight of the composition. In one embodiment, optionally, fibers (e.g., carbon, ceramic, or metal) can be incorporated into the polymer to enhance thermal conductivity, subject to compatibility with optical and/or aesthetic requirements.

As previously described, the polymers described herein incorporating a phase change material therein, can be made into articles, such as a glazing. However, it is to be understood that the polymers described herein can be formed into any article in which the use of a phase change material to e.g., lower the time-average total solar transmittance and/or to increase the service life of the article (e.g., by decreasing cumulative expansion and contraction and/or decreasing effective temperature), is desired. Thus, although glazing is discussed throughout the application, other uses are intended and contemplated, including, but not limited to, appliques, building and construction application, and the like.

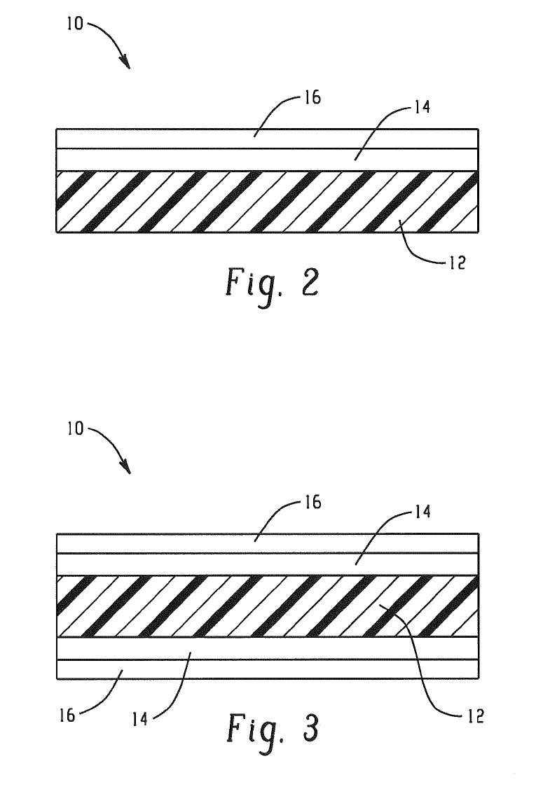

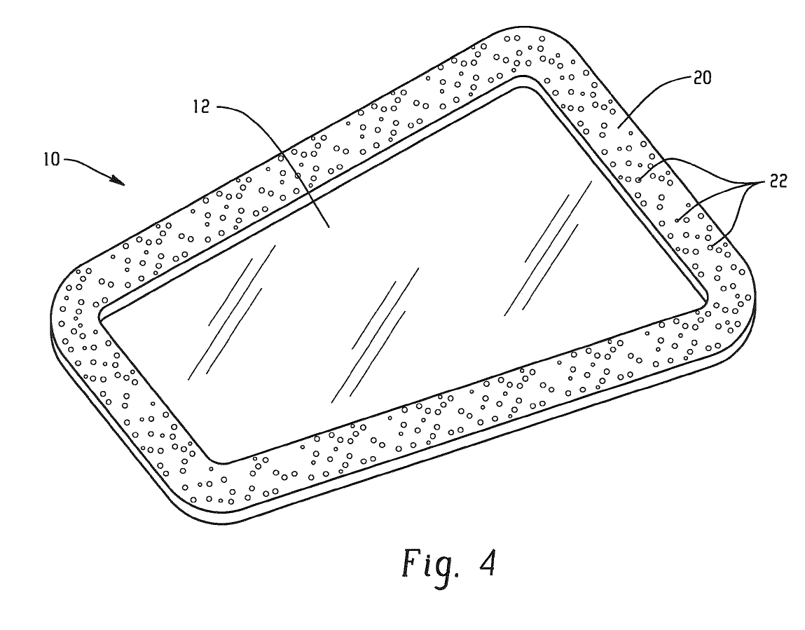

As illustrated in FIGS. 2 and 3, a glazing 10 can generally comprise a substrate 12, a weathering layer 14 disposed on either or both sides of the substrate 12, e.g., for protection against ultraviolet radiation, and an abrasion resistant layer 16 disposed on either or both sides of the substrate 12, e.g., to protect the substrate 12 from scratches or debris related damage. When the weathering layer 14 and abrasion resistant layer 16 are both present, the weathering layer 14 can be located between the substrate 12 and the abrasion resistant layer 16. The substrate 12 can be transparent or opaque. A glazing 10 comprising a transparent substrate 12 can further comprise an optional integrated dark border (blackout border), e.g., the second shot in a two-shot injection molding process. For example, as seen in FIG. 4, a glazing 10 can comprise a transparent substrate 12 and a dark border 20 disposed around a perimeter of the substrate 12 with a PCM 22 incorporated in the dark border 20. The PCM 22 can be incorporated into the substrate material and/or into the border material of the glazing 10. For example, a two-shot injection molded article can be configured with the PCM differentiated in the two shots.

An advantage of incorporating the PCM into the border material of the glazing, which can generally be dark (e.g., black second shot in a two-shot injection molding process) can be the inclusion of the PCM with the benefits provided without concern to any effects on transparency. For example, selection of a PCM, when incorporated into the border material, has more flexibility with respect to the material, size, and loading, as compared to when a PCM is incorporated into a transparent substrate.

The substrate can comprise a transparent plastic such as polycarbonate resin, acrylic polymers, polyacrylate, polyester, polysulfone resins, as well as combinations comprising at least one of the foregoing. In some embodiments the substrate can comprise an opaque plastic allowing less than or equal to 1% of visible light to transfer through it (e.g., automotive appliques, automotive body panel applications, etc.), while in other embodiments, the substrate can comprise a transparent plastic allowing greater than or equal to 5% of visible light to transfer through it (e.g., front windshield, driver's side window, rooflite, all other vehicle windows, etc.). Visible light transmittance can be determined in accordance with the American Society for Testing Materials (ASTM) standard D1003-11, Procedure A using Commission Internationale de L'Eclairage (CIE) standard illuminant C (see e.g., International Standards Organization (ISO) 10526). The polycarbonate resins can be aromatic carbonate polymers which may be prepared by reacting dihydric phenol(s) with a carbonate precursor such as phosgene, a haloformate, or a carbonate ester. One example of a polycarbonate which can be used is polycarbonate LEXAN™, commercially available from SABIC'S Innovative Plastics Business. The plastic substrate can include bisphenol-A polycarbonate and other resin grades (such as branched or substituted) as well as being copolymerized or blended with other polymers such as polybutylene terephthalate (PBT), poly-(acrylonitrile-butadiene-styrene) (ABS), or polyethylene.

Acrylic polymers can be prepared from monomers such as methyl acrylate, acrylic acid, methacrylic acid, methyl methacrylate, butyl methacrylate, cyclohexyl methacrylate, and the like, as well as combinations comprising at least one of the foregoing. Substituted acrylates and methacrylates, such as hydroxyethyl acrylate, hydroxybutyl acrylate, 2-ethylhexylacrylate, and n-butylacrylate can also be used.

Polyesters can be prepared, for example by the polyesterification of organic polycarboxylic acids (e.g., phthalic acid, hexahydrophthalic acid, adipic acid, maleic acid, terephthalic acid, isophthalic acid, sebacic acid, dodecanedioic acid, and so forth) or their anhydrides with organic polyols containing primary or secondary hydroxyl groups (e.g., ethylene glycol, butylene glycol, neopentyl glycol, and cyclohexanedimethanol).

Polyurethanes are another class of materials which can be used to form the substrate. Polyurethanes can be prepared by the reaction of a polyisocyanate, with a polyol, polyamine, or water. Examples of polyisocyanates include hexamethylene diisocyanate, toluene diisocyanate, diphenylmethane diisocyanate (MDI), isophorone diisocyanate, and biurets and thisocyanurates of these diisocyanates. Examples of polyols include low molecular weight aliphatic polyols, polyester polyols, polyether polyols, fatty alcohols, and the like. Examples of other materials from which the substrate can be formed include CYCOLAC™ (acrylonitrile-butadiene-styrene, commercially available from SABIC'S Innovative Plastics Business), CYCOLOY™ (a blend of LEXAN™ and CYCOLAC™, commercially available from SABIC'S Innovative Plastics Business), VALOX™ (polybutylene terephthalate, commercially available from SABIC'S Innovative Plastics Business), XENOY™ (a blend of LEXAN™ and VALOX™, commercially available from SABIC'S Innovative Plastics Business), and the like.

The plastic substrate can further comprise various additives, such as impact modifiers, fillers, reinforcing agents, antioxidants, heat stabilizers, light stabilizers, ultraviolet (UV) light stabilizers (e.g., UV absorbing), plasticizers, lubricants, mold release agents, antistatic agents, colorants (such as carbon black and organic dyes), surface effect additives, infrared radiation stabilizers (e.g., infrared absorbing), flame retardants, thermal conductivity enhancers, and anti-drip agents.

The substrate can be formed in various manners such as by injection molding, extrusion, cold forming, vacuum forming, compression molding, transfer molding, thermal forming, and so forth. An article may be in any shape and need not be a finished article of commerce, that is, it may be sheet material or film which would be cut or sized or mechanically shaped into a finished article.

A weathering layer can be applied to the substrate. For example, the weathering layer can be a coating having a thickness of less than or equal to 100 micrometers (μm), specifically, 4 μm to 65 μm. The weathering layer can be applied by various means, including dipping the plastic substrate in a coating solution at room temperature and atmospheric pressure (i.e., dip coating). The weathering layer can also be applied by other methods including, but not limited to, flow coating, curtain coating, and spray coating. The weathering layer can comprise silicones (e.g., a silicone hard coat), polyurethanes (e.g., polyurethane acrylate), acrylics, polyacrylate (e.g., polymethacrylate, polymethyl methacrylate), polyvinylidene fluoride, polyesters, epoxies, and combinations comprising at least one of the foregoing. The weathering layer 14 can include ultraviolet absorbing molecules (e.g., such as hydroxyphenylthazine, hydroxybenzophenones, hydroxylphenylbenzothazoles, hydroxyphenyltriazines, polyaroylresorcinols, and cyanoacrylate, as well as combinations comprising at least one of the foregoing). For example, the weathering layer can comprise a silicone hard coat layer (AS4000 or AS4700, commercially available from Momentive Performance Materials).

The weathering layer can comprise a primer layer and a coating (e.g., a top coat). A primer layer can aid in adhesion of the weathering layer to the substrate. The primer layer can include, but is not limited to, acrylics, polyesters, epoxies, and combinations comprising at least one of the foregoing. The primer layer can also include ultraviolet absorbers in addition to or in place of those in the top coat of the weathering layer. For example, the primer layer can comprise an acrylic primer (SHP401 or SHP470, commercially available from Momentive Performance Materials).

The abrasion resistant layer (e.g., a coating, or plasma coating) can comprise a single layer or a multitude of layers and can add enhanced functionality by improving abrasion resistance of the glazing. Generally, the abrasion resistant layer can comprise an organic coating and/or an inorganic coating such as, but not limited to, aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon carbide, silicon oxy carbide, hydrogenated silicon oxy-carbide, tantalum oxide, titanium oxide, tin oxide, indium tin oxide, yttrium oxide, zinc oxide, zinc selenide, zinc sulfide, zirconium oxide, zirconium titanate, glass, and combinations comprising at least one of the foregoing.

The abrasion resistant layer can be applied by various deposition techniques such as vacuum assisted deposition processes and atmospheric coating processes. For example, vacuum assisted deposition processes can include, but are not limited to, plasma enhanced chemical vapor deposition (PECVD), arc-PECVD, expanding thermal plasma PECVD, ion assisted plasma deposition, magnetron sputtering, electron beam evaporation, and ion beam sputtering.

Optionally, one or more of the layers (e.g., weathering layer and/or abrasion resistant layer) can be a film applied to the substrate by a method such as lamination or film insert molding. In this case, the functional layer(s) or coating(s) could be applied to the film and/or to the side of the substrate opposite the side with the film. For example, a co-extruded film, an extrusion coated, a roller-coated, or an extrusion-laminated film comprising greater than one layer can be used as an alternative to a hard coat (e.g., a silicone hard coat) as previously described. The film can contain an additive or copolymer to promote adhesion of the weathering layer (i.e., the film) to an abrasion resistant layer, and/or can itself comprise a weatherable material such as an acrylic (e.g., polymethylmethacrylates), fluoropolymer (e.g., polyvinylidene fluoride, polyvinyl fluoride), etc., and/or can block transmission of ultraviolet radiation sufficiently to protect the underlying substrate; and/or can be suitable for film insert molding (FIM) (in-mold decoration (IMD)), extrusion, or lamination processing of a three dimensional shaped panel.

Various additives can be added to the various layers of the glazing such as colorant(s), antioxidant(s), surfactant(s), plasticizer(s), infrared radiation absorber(s), antistat(s), antibacterial(s), flow additive(s), dispersant(s), compatibilizer(s), cure catalyst(s), ultraviolet radiation absorber(s), and combinations comprising at least one of the foregoing. The type and amounts of any additives added to the various layers depends on the desired performance and end use of the glazing.

A polycarbonate sub-layer (e.g., cap layer) can be co-extruded with, or extrusion laminated to, a weathering film or another functional layer, as a carrier sub-layer. This polycarbonate carrier sub-layer, which can be transparent, can assist in supporting the formation and structure of the weathering layer or other function layer, as well as optionally providing for melt bonding of the carrier sub-layer to a substrate during film insert molding. The carrier sub-layer can accommodate a mismatch in coefficient of thermal expansion (CTE) between the substrate and the weathering film or other functional layer. The polycarbonate used as the carrier sub-layer can support the inclusion of additional functionality, such as a printed black-out/fade-out or defroster and the like, and/or a graphics film and the like. It is to be understood that the PCMs disclosed herein can be in any layer of the polymer parts disclosed herein including, but not limited to a film insert molded layer, an in-mold coating layer, a cap layer, a weathering layer, an abrasion resistant layer, and combinations comprising at least one of the foregoing.

For example, a glazing part can comprise a first layer comprising a first polymer and a phase change material and a second layer comprising a second polymer. When the glazing part is exposed to cyclic temperature and solar radiation conditions for a period of time, a time-average total solar transmittance of the glazing part can be reduced compared to a glazing part without a phase change material exposed to the same cyclic temperature and solar radiation conditions for the same period of time. The glazing part disclosed herein can further comprise an optional third layer that can be a film insert molded layer, an in-mold coating layer, a cap layer, a weathering layer, an abrasion resistant layer, and combinations comprising at least one of the foregoing. The first layer can comprise a transparent portion and the second layer can comprise a blackout portion (e.g., blackout border), with a phase change material optionally incorporated into the blackout portion.

Exemplary PCMs include, but are not limited to, zeolite powder, polytriphenylphosphate, crystalline paraffin wax, polyethyleneglycol, fatty acid, naphthalene, calcium bichloride, polyepsilon caprolactone, polyethylene oxide, polyisobutylene, polycyclopentene, polycyclooctene, polycyclododecene, polyisoprene, polyoxytriethylene, polyoxytetramethylene, polyoxyoctamethylene, polyoxypropylene, polybutyrolactone, polyvalerolactone, polyethyleneadipate, polyethylene suberate, polydecamethylazelate, and combinations comprising at least one of the foregoing.

The PCM can be implemented in various forms, including, but not limited to discretely encapsulated PCM particles with diameters of a few micrometers or as a shape-stabilized PCM where the shape of a PCM in its solid or liquid phase is maintained by a supporting structure such as a polymeric matrix. The encapsulant can, for example, comprise a microsphere (e.g., with glass or polymer as the encapsulant). In such a case, the PCM can be discretely encapsulated by the microsphere. The PCM can be incorporated into the polymer in various locations, including, but not limited to, incorporation in a first shot and/or a second shot for two-shot injection molded components. For example, PCM incorporated into the first and second shots can include PCMs with different respective forms (e.g., discretely encapsulated PCM particles or shape-stabilized PCM particles), and/or sizes, and/or materials, and/or loadings. When incorporating a PCM into the second shot in a two-shot injection molding process, where the second shot can generally be opaque or relatively dark, the loading, and/or size, and/or material, and/or form of the PCM in the second shot would not be limited by specifications for optical transmission and/or haze.

For example, a two-shot injection molded glazing article can be configured with the PCM in the second shot so as to approach or achieve a uniform effective temperature throughout the article. Uniform effective temperature as used herein in relation to a glazing article, generally refers to the temperature being the same in the transparent day light opening of the substrate and in the dark border. The dark border without a PCM incorporated therein can be a weak link in the weatherability of an article (e.g., glazing). Without wishing to be limited by theory, it is believed that incorporation of a PCM in the dark border can allow the dark border to last as long as the day light opening so that it ceases to be the limiting element in the effective service life of the article.

In some embodiments, the refractive index of the polymer and the refractive index of the PCM can be made substantially equal so that there is no substantial change in the transparency of the material. By substantially equal is meant that the values of the refractive indices are within 10% of one another, specifically 5%, more specifically, 2.5%.

Methods of making the parts disclosed herein (e.g., polymer parts, glazing parts, etc.) are also contemplated. For example, a method of making a polymer part can comprise molding (e.g., injection molding) a first layer comprising a first polymer, where the first layer allows greater than or equal to 5% of visible light to transfer though it, molding (e.g., injection molding) an opaque second layer comprising a second polymer, incorporating a phase change material in at least one of the first polymer or the second polymer; and exposing the polymer part to cyclic temperature and solar radiation conditions for a period of time. A method of making a polymer part can also comprise forming (e.g., extruding, molding, injection molding, etc.) a first layer comprising a first polymer. The first layer can comprise a phase change material. The first layer can be opaque or the first layer can be transparent (e.g., can allow greater than or equal to 5% of visible light to transfer through it). The part can have a lower effective temperature as compared to a polymer part without a phase change material when exposed to the same cyclic temperature and solar radiation conditions for the same period of time. A method of making a glazing part can comprise forming (e.g., extruding, molding, injection molding, etc.) a first layer comprising a first polymer and a phase change material and molding a second layer comprising a second polymer.

A method of making an article can comprise forming (e.g., extruding, molding, injection molding, etc.) a polymer part comprising a first layer comprising a first material and a phase change material, bonding or coating a second layer comprising a second material to the first layer, and exposing the article to cyclic temperature and/or solar radiation conditions such that the article can have a reduced cumulative differential thermal expansion between the first and second layers as compared to an article without a phase change material exposed to the same cyclic temperature and/or solar radiation conditions for the same period of time. The first material can comprise a polymer (e.g., thermoplastic, thermoset, etc.) and the second material can comprise a polymer, a metal, glass, ceramic, etc.

The polymers comprising a PCM and articles made therefrom as disclosed herein can offer several advantages and improvements as compared to polymers that do not comprise a PCM. For example, improvements in service lifetime can be observed by decreasing the effective temperature of a polymer part with the inclusion of a PCM, by relieving the tradeoff between weathering and abrasion resistance of a coating on the polymer part, since inclusion of a PCM in a polymer formed into a part improves the weathering performance independently of UV absorber loading (where high amounts of UV absorber can decrease abrasion resistance of the coating), and by improving consistency of weathering performance across geographical regions with different effective temperatures. Another improvement that can be seen is the mitigation of bonding and/or coating fatigue from cyclic thermal expansion and contraction. Still another improvement can be found in a decrease in time-average total solar transmittance on transparent parts in relatively hot climates. The polymers comprising a PCM and articles or parts made therefrom can provide several benefits and improvements as compared to polymers and articles or parts that do not comprise a PCM.

Embodiment 1: a polymer part, comprising: a first layer comprising a first polymer and a phase change material, wherein the first layer allows greater than or equal to 5% of visible light to transfer through it; and wherein when exposed to cyclic temperature and solar radiation conditions for a period of time, the polymer part has a lower effective temperature as compared to a polymer part without a phase change material when exposed to the same cyclic temperature and solar radiation conditions for the same period of time.

Embodiment 2: a polymer part, comprising: a first layer comprising a first polymer, wherein the first layer allows greater than or equal to 5% of visible light to transfer through it; and a second layer comprising a second polymer and a phase change material, wherein the second layer is opaque; wherein when exposed to cyclic temperature and solar radiation conditions for a period of time, the polymer part has a lower effective temperature as compared to a polymer part without a phase change material when exposed to the same cyclic temperature and solar radiation conditions for the same period of time.

Embodiment 3: The polymer part of Claim 2, wherein the first layer has a perimeter and wherein the second layer is disposed around the perimeter of the first layer.

Embodiment 4: The polymer part of any of Claims 2-3, wherein a phase change material is incorporated in the first layer.

Embodiment 5: The polymer part of any of Claims 2-4, wherein the first layer comprises a transparent portion and the second layer comprises a blackout portion and wherein the phase change material is incorporated in the blackout portion.

Embodiment 6: The polymer part of Claim 5, wherein the blackout portion is printed on the first layer.

Embodiment 7: The polymer part of Claim 5, wherein the blackout portion is the second shot in a two-shot injection molding process.

Embodiment 8: The polymer part of any of Claims 2-7, wherein the second polymer comprises polycarbonate, acrylonitrile butadiene styrene, and a combination comprising at least one of the foregoing.

Embodiment 9: The polymer part of any of Claims 1-8, wherein the phase change material is encapsulated in a microsphere.

Embodiment 10: The polymer part of any of Claims 1-9, wherein the phase change material is shape-stabilized.

Embodiment 11: A polymer part, comprising: an opaque first layer comprising a first polymer and a phase change material; wherein when exposed to cyclic temperature and solar radiation conditions for a period of time, the polymer part has a lower effective temperature as compared to a polymer part without a phase change material exposed to the same cyclic temperature and solar radiation conditions for the same period of time.

Embodiment 12: The polymer part of any of Claims 1-11, wherein an average temperature of the part is reduced as compared to a similar part without a phase change material.

Embodiment 13: The polymer part of any of Claims 1-12, wherein a service lifetime of the polymer part is increased as compared to a similar part without a phase change material.

Embodiment 14: The polymer part of any of Claims 1-13, wherein the polymer part is an applique, an automotive body panel, a glazing component, a headlamp component, a building component, or a combination comprising at least one of the foregoing.

Embodiment 15: The polymer part of any of Claims 1-14, wherein the polymer part is a glazing component.

Embodiment 16: The polymer part of any of Claims 1-15, further comprising an additional layer that is a film insert molded layer, an in-mold coating layer, a cap layer, a weathering layer, an abrasion resistant layer, and combinations comprising at least one of the foregoing.

Embodiment 17: The polymer part of Claim 16, wherein the additional layer comprises a phase change material.

Embodiment 18: The polymer part of any of Claims 1-17, wherein the first polymer comprises polycarbonate, acrylonitrile butadiene styrene, and a combination comprising at least one of the foregoing.

Embodiment 19: an article, comprising: a polymer part comprising a first layer comprising a first material and a phase change material; and a second layer comprising a second material, wherein the second layer is bonded to the first layer or wherein the second layer is coated on the first layer; wherein when the article is exposed to cyclic temperature and/or solar radiation conditions for a period of time, differential thermal expansion of the first layer and second layer is reduced compared to an article without a phase change material exposed to the same cyclic temperature and/or solar radiation conditions for the same period of time.

Embodiment 20: the article of Embodiment 19, wherein the first material comprises a polymer.

Embodiment 21: the article of any of Embodiments 19-20, wherein the first material and/or the second material comprise a polymer selected from the group consisting of polycarbonate, acrylonitrile butadiene styrene, and a combination comprising at least one of the foregoing.

Embodiment 22: a glazing part, comprising: a first layer comprising a first polymer and a phase change material; wherein when the glazing part is exposed to cyclic temperature and solar radiation conditions for a period of time, a time-average total solar transmittance of the glazing part is reduced compared to a glazing part without a phase change material exposed to the same cyclic temperature and solar radiation conditions for the same period of time.

Embodiment 23: the glazing part of Embodiment 22, wherein the glazing part further comprises a second layer comprising a second polymer.

Embodiment 24: the glazing part of any of Embodiments 22-23, wherein the first polymer and/or the second polymer comprise a material selected from polycarbonate, acrylonitrile butadiene styrene, and a combination comprising at least one of the foregoing.

Embodiment 25: the glazing part of any of Embodiments 22-24, wherein the glazing part further comprises a third layer that is a film insert molded layer, an in-mold coating layer, a cap layer, a weathering layer, an abrasion resistant layer, and a combination comprising at least one of the foregoing.

Embodiment 26: the glazing part of Embodiment 25, wherein the third layer comprises a phase change material.

Embodiment 27: the glazing part of any of Embodiments 23-26, wherein the first layer comprises a transparent portion, the second layer comprises a blackout portion, and wherein a phase change material is incorporated in the blackout portion.

Embodiment 28: a method of making a polymer part, comprising: molding a first layer comprising a first polymer, wherein the first layer allows greater than or equal to 5% of visible light to transfer through it; molding a second layer comprising a second polymer, wherein the second layer is opaque; incorporating a phase change material in at least one of the first polymer or the second polymer; and exposing the polymer part to cyclic temperature and solar radiation conditions for a period of time; wherein the polymer part has a lower effective temperature as compared to a polymer part without a phase change material when exposed to the same cyclic temperature and solar radiation conditions for the same period of time.

Embodiment 29: a method of making a polymer part, comprising: forming a first layer comprising a first polymer and a phase change material, wherein the first layer allows greater than or equal to 5% of visible light to transfer through it; and exposing the polymer part to cyclic temperature and solar radiation conditions for a period of time; wherein the polymer part has a lower effective temperature as compared to a polymer part without a phase change material when exposed to the same cyclic temperature and solar radiation conditions for the same period of time.

Embodiment 30: a method of making a polymer part, comprising: forming an opaque first layer, wherein the first layer comprises a first polymer; incorporating a phase change material in the first polymer; and exposing the polymer part to cyclic temperature and solar radiation conditions for a period of time; wherein the polymer part has a lower effective temperature as compared to a polymer part without a phase change material when exposed to the same cyclic temperature and solar radiation conditions for the same period of time.

Embodiment 31: a method of making an article, comprising: forming a polymer part comprising a first layer comprising a first material and a phase change material to form the article; bonding or coating a second layer comprising a second material to the first layer; and exposing the article to cyclic temperature and/or solar radiation conditions; wherein when the article is exposed to cyclic temperature and/or solar radiation conditions for a period of time, differential thermal expansion of the first layer and second layer is reduced compared to an article without a phase change material exposed to the same cyclic temperature and/or solar radiation conditions for the same period of time.

Embodiment 32: A method of making a glazing part, comprising: forming a first layer comprising a first polymer and a phase change material; and exposing the glazing part to cyclic temperature and solar radiation conditions for a period of time; wherein a time-average total solar transmittance of the glazing part is reduced compared to a glazing part without a phase change material when exposed to the same cyclic temperature and solar radiation conditions for the same period of time.

Embodiment 33: The method of Embodiment 32, further comprising forming a second layer comprising a second polymer.

Embodiment 34: The method of any of Embodiments 28 and 33, wherein the second polymer comprises polycarbonate, acrylonitrile butadiene styrene, or a combination comprising at least one of the foregoing.

Embodiment 35: The method of any of Embodiments 28-34, wherein the first polymer comprises polycarbonate, acrylonitrile butadiene styrene, or a combination comprising at least one of the foregoing.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to differentiate one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. “Optional” or “optionally” means that the subsequently described event or circumstance can or cannot occur, and that the description includes instances where the event occurs and instances where it does not.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group. In addition, it is to be understood that the described elements may be combined in any suitable manner in the various embodiments.

With respect to the figures, it is noted that these figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the description for the sake of clarity, these terms are intended to refer only to the particular structure of the embodiments selected for illustration in the drawings, and are not intended to define or limit the scope of the disclosure. In the drawings and the description herein, it is to be understood that like numeric designations refer to components of like function.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A polymer part, comprising:
a first layer comprising a first polymer, wherein the first layer allows greater than or equal to 5% of visible light to transfer through it;
optionally a second layer comprising a second polymer and a phase change material, wherein the second layer is opaque;
wherein the first layer comprises a phase change material or, if the second layer is present, one or both of the first layer and the second layer comprises the phase change material; and
wherein when exposed to cyclic temperature and solar radiation conditions for a period of time, the polymer part has a lower effective temperature as compared to a polymer part without a phase change material when exposed to the same cyclic temperature and solar radiation conditions for the same period of time.

2. The polymer part of claim 1, wherein the phase change material is encapsulated in a microsphere and/or is shape-stabilized.

3. The polymer part of claim 1, wherein an average temperature of the part is reduced as compared to a similar part without a phase change material.

4. The polymer part of claim 1, wherein a service lifetime of the polymer part is increased as compared to a similar part without a phase change material.

5. The polymer part of claim 1, wherein the polymer part is an applique, an automotive body panel, a glazing component, a headlamp component, a building component, or a combination comprising at least one of the foregoing.

6. The polymer part of claim 1, wherein the polymer part is a glazing component.

7. The polymer part of claim 1, further comprising an additional layer that is a film insert molded layer, an in-mold coating layer, a cap layer, a weathering layer, an abrasion resistant layer, and combinations comprising at least one of the foregoing.

8. The polymer part of claim 1, wherein the first polymer comprises polycarbonate, acrylonitrile butadiene styrene, and a combination comprising at least one of the foregoing.

9. The polymer part of claim 1, wherein the second layer is present and wherein the second layer comprises the phase change material.

10. The polymer part of claim 9, wherein the first layer has a perimeter and wherein the second layer is disposed around the perimeter of the first layer.

11. The polymer part of claim 9, wherein a first layer phase change material is incorporated in the first layer.

12. The polymer part of claim 9, wherein the first layer comprises a transparent portion and the second layer comprises a blackout portion and wherein the phase change material is incorporated in the blackout portion.

13. The polymer part of claim 12, wherein the blackout portion is printed on the first layer.

14. The polymer part of claim 12, wherein the blackout portion is the second shot in a two-shot injection molding process.

15. The polymer part of claim 9, wherein the second polymer comprises polycarbonate, acrylonitrile butadiene styrene, and a combination comprising at least one of the foregoing.

16. A polymer part, comprising:
an opaque first layer comprising a polycarbonate and a phase change material;
wherein when exposed to cyclic temperature and solar radiation conditions for a period of time, the polymer part has a lower effective temperature as compared to a polymer part without a phase change material exposed to the same cyclic temperature and solar radiation conditions for the same period of time.

17. A method of making a polymer part, comprising:
molding forming a first layer comprising a first polymer, wherein the first layer allows greater than or equal to 5% of visible light to transfer through it;
optionally molding a second layer comprising a second polymer, wherein the second layer is opaque;
incorporating a phase change material in the first polymer, or, if the second layer is present, incorporating the phase change material in at least one of the first polymer or the second polymer; and
exposing the polymer part to cyclic temperature and solar radiation conditions for a period of time;
wherein the polymer part has a lower effective temperature as compared to a polymer part without a phase change material when exposed to the same cyclic temperature and solar radiation conditions for the same period of time.

18. The method of claim 17, wherein the second layer is present and wherein the second layer comprises the phase change material.

19. A method of making a polymer part, comprising:
forming an opaque first layer, wherein the first layer comprises a polycarbonate;
incorporating a phase change material in the first polymer; and
exposing the polymer part to cyclic temperature and solar radiation conditions for a period of time;
wherein the polymer part has a lower effective temperature as compared to a polymer part without a phase change material when exposed to the same cyclic temperature and solar radiation conditions for the same period of time.

20. The method of claim 19, wherein the second polymer comprises polycarbonate, acrylonitrile butadiene styrene, or a combination comprising at least one of the foregoing.
